(19) United States
(12) Patent Application Publication
(10) Pub. No.: US 2018/0264566 A1
(43) Pub. Date: Sep. 20, 2018

(54) RECIPROCATING SAW

(71) Applicant: MILWAUKEE ELECTRIC TOOL CORPORATION, Brookfield, WI (US)

(72) Inventor: Andrew J. Smith, Waukesha, WI (US)

(21) Appl. No.: 15/914,272

(22) Filed: Mar. 7, 2018

Related U.S. Application Data
(60) Provisional application No. 62/473,719, filed on Mar. 20, 2017.

(51) Int. Cl. B23D 51/16; B23D 51/01; B23D 51/10; B25F 5/02; F16H 1/12; F16H 21/22

(52) U.S. Cl. CPC B23D 51/16; B23D 51/01; F16H 21/22; B25F 5/02; F16H 1/12; B23D 51/10

(57) ABSTRACT

A power tool including a housing having a handle configured to be grasped by a user, a motor supported by the housing, a driving gear rotated by the motor and having a substantially cylindrical body, and a driven gear engaging the driving gear to be rotated by the driving gear about a rotation axis. The power tool also includes a pin extending from the driven gear and offset from the rotation axis, a spindle having a yoke coupled to the pin to translate rotation of the driven gear into reciprocating motion of the spindle, and a tool element coupled to the spindle for reciprocating motion with the spindle.

### CROSS-REFERENCE TO RELATED APPLICATIONS

This application claims priority to U.S. Provisional Application No. 62/473,719, filed Mar. 20, 2017, the entire contents of which are hereby incorporated by reference.

### BACKGROUND

The present invention relates to a power tool. In particular, the present invention relates to a reciprocating saw. Reciprocating saws are used to cut a variety of objects made from a variety of materials, such as metal pipes, wood and dry wall. A cordless, compact reciprocating saw allows for cutting operations in tight spaces or awkward angles for plumbing, electrical, remodeling and HVAC applications.

### SUMMARY

In one embodiment, the invention provides a power tool including a housing having a handle configured to be grasped by a user, a motor supported by the housing, a driving gear rotated by the motor and having a substantially cylindrical body, and a driven gear engaging the driving gear to be rotated by the driving gear about a rotation axis. The power tool also includes a pin extending from the driven gear and offset from the rotation axis, a spindle having a yoke coupled to the pin to translate rotation of the driven gear into reciprocating motion of the spindle, and a tool element coupled to the spindle for reciprocating motion with the spindle.

In another embodiment the invention provides a power tool including a housing having a handle configured to be grasped by a user, a motor supported by the housing, a driving gear rotated by the motor, and a driven gear engaging the driving gear to be rotated by the driving gear about a rotation axis. The driving gear has a first end and a second end, and a dimension of the first end is substantially the same as a dimension of the second end. The power tool also includes a pin extending from the driven gear and offset from the rotation axis, a spindle having a yoke coupled to the pin to translate rotation of the driven gear into reciprocating motion of the spindle, and a tool element coupled to the spindle for reciprocating motion with the spindle.

In another embodiment the invention provides a drive system for a power tool. The drive system includes a driving gear configured to be rotated by a motor and a driven gear engaging the driven gear to be rotated by the driving gear about a rotational axis. The driving gear has a substantially cylindrical body, and the driven gear is configured to actuate a tool element. The driving gear, the driven gear, or both the driving gear and the driven gear is molded of powered metal.

Other aspects of the invention will become apparent by consideration of the detailed description and accompanying drawings.

### BRIEF DESCRIPTION OF THE DRAWINGS

FIG. 1 is a perspective view of a reciprocating saw according to one embodiment of the invention.

FIG. 2 is perspective side view of the reciprocating saw shown in FIG. 1.

FIG. 3 is a cross-sectional view of the reciprocating saw of FIG. 1.

FIG. 4A is a perspective view of a driving gear of the reciprocating saw of FIG. 1.

FIG. 4B is a side view of the driving gear of the reciprocating saw of FIG. 4A.

FIG. 5 is a perspective view of a driven gear of the reciprocating saw of FIG. 1.

FIG. 6 is a plan view of the driven gear of FIG. 5.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

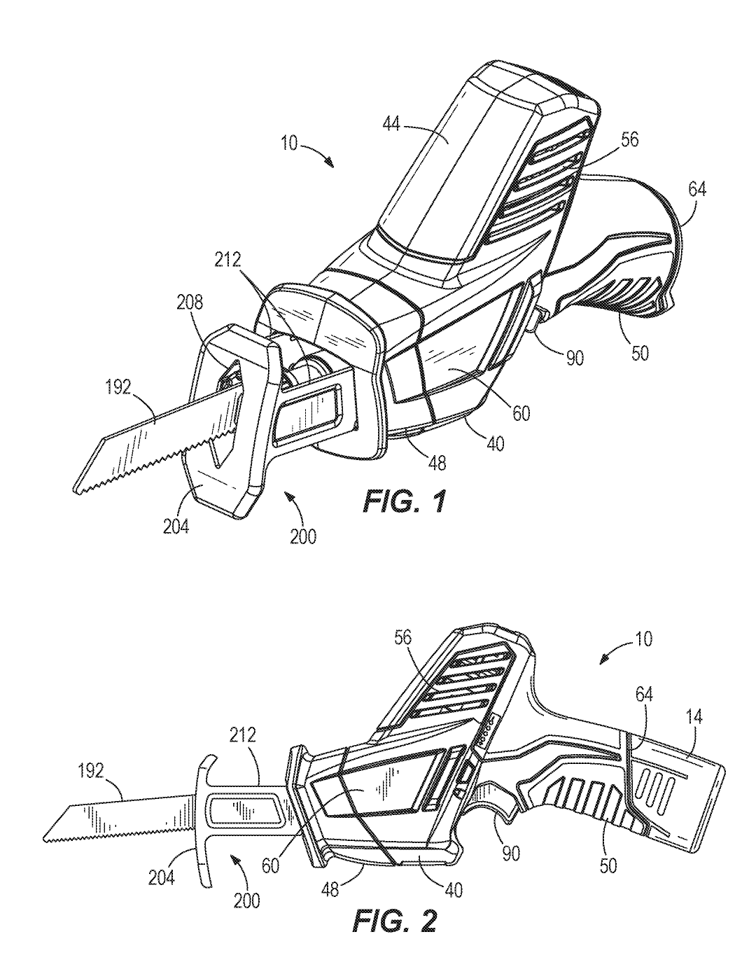

A portable power tool 10 is shown in FIGS. 1-3. In these embodiments, the power tool 10 is a reciprocating saw. In the illustrated embodiments, the saw 10 is powered by a power tool battery pack 14. The battery pack 14 may be configured to connect to and power a variety of tools in addition to the reciprocating saw 10. In other embodiments, the saw 10 may be a corded power tool. In still other embodiments, the power tool may be another hand-held power tool, such as, for example, another type of power tool that translates rotary motion into reciprocating motion.

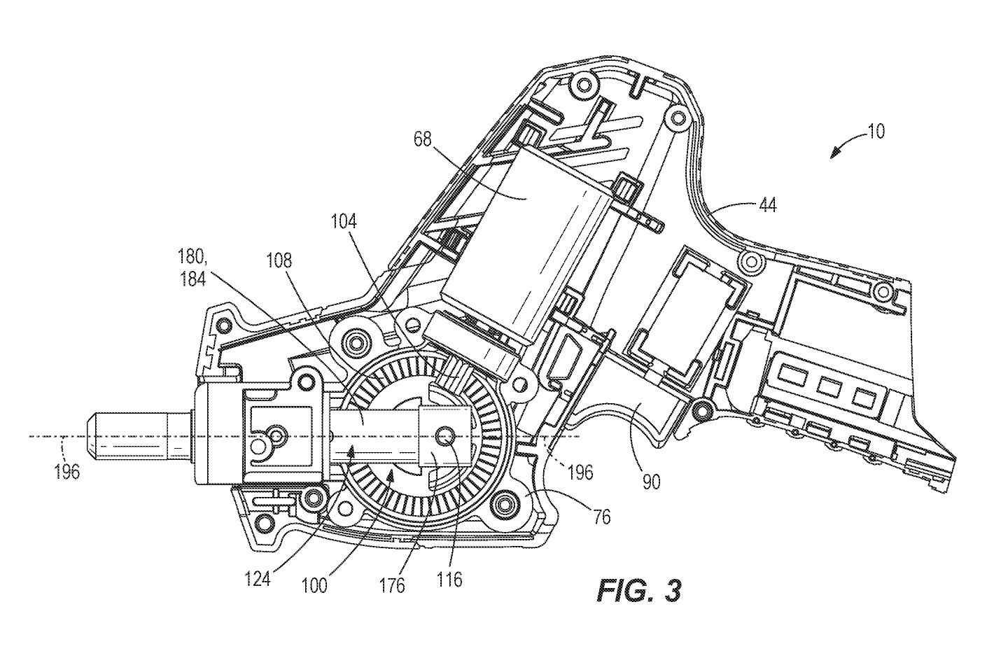

The saw 10 includes a housing 40. As shown in FIG. 1, the housing 40 has a first housing portion 44 and a second housing portion 48. Each housing portion 44, 48 is formed of plastic; however, in some embodiments, the housing portions 44, 48 may be formed of other materials. The housing 40 defines a handle housing portion 50, a motor housing portion 56, and a gear case housing portion 60. The handle housing portion 50 includes at least one grip surface for a user to grasp. In the illustrated embodiments, the handle housing portion 50 can also define a battery receiving portion 64 for receiving the battery pack 14. In other embodiments, the battery receiving portion 64 may be defined elsewhere within the housing 40. The motor housing portion 56 supports a motor 68 (FIG. 3). The gear case housing portion 60 supports a gear case (FIGS. 2 and 3). The gear case includes first and second gear case portions 76, only one of which is shown in FIG. 3.

As shown in FIG. 1, the battery receiving portion 64 is configured as a cavity. As shown in FIG. 2, when the battery pack 14 is connected to the saw 10, the battery pack 14 is inserted into the cavity and substantially closes the cavity. As shown in FIGS. 1-3, a switch 90 is positioned on the handle housing portion 50 and electrically coupled to the battery pack 14 for powering the saw 10. As illustrated, the switch 90 is an on/off trigger switch. In other embodiments, the switch 90 may be a variable speed trigger switch, a two speed trigger switch, a push button or other actuator.

Referring to FIG. 3, the first and second gear case portions 76 enclose a drive system 100 for the saw 10. In this embodiment, the drive system 100 is a scotch yoke mechanism. The illustrated drive system 100 includes a driving gear 104, a driven gear or face gear 108, a pin 116 connected to the driven gear 108, and a yoke 124. The driving gear 104, or motor pinion, is coupled to an output shaft of the motor 68 and rotated by the motor 68. The driving gear 104 engages and rotates the driven gear 108 about an axis of rotation, which is perpendicular to the page at the point 126 in FIG. 6. The pin 116 extends from the driven gear 108 and is offset from the axis of rotation 126. As the driven gear 108 rotates, the pin 116 moves about the axis of rotation 126 to reciprocate the yoke 124. As such, rotation of the motor output shaft is translated into reciprocating motion by the drive system 100.

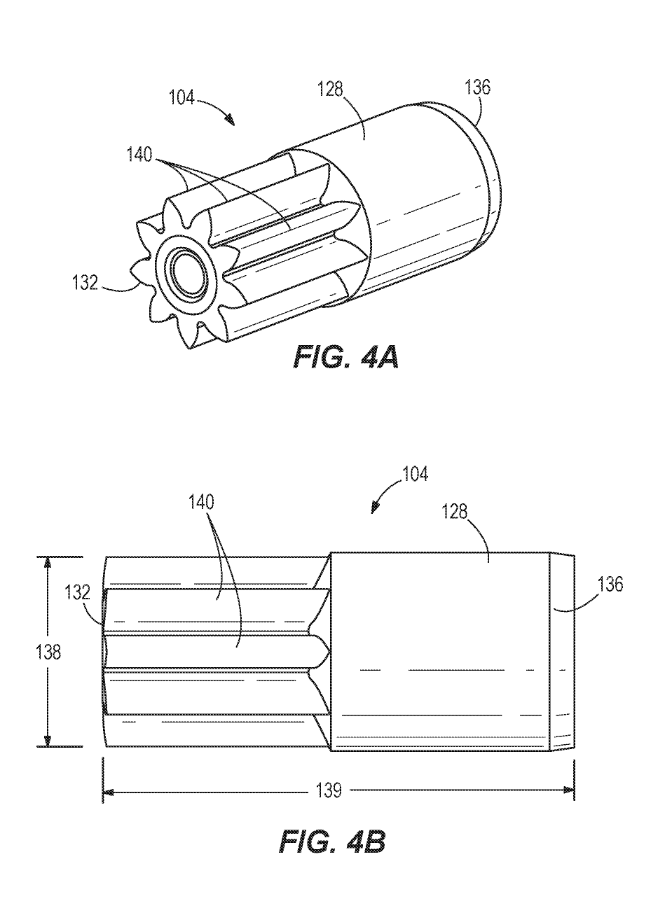

With respect to FIGS. 4A and 4B, the driving gear 104 includes a substantially cylindrical body 128 with a first end 132 and a second end 136. That is the driving gear 104 defines a dimension 138 (e.g., diameter) that is constant or uniform along a length 139 of the body 128. Accordingly, the dimension 138 at the first end 132 is the same as the dimension 138 at the second end 136. The first end 132 also includes a plurality of teeth 140. The second end 136 connects to the output shaft of the motor 68. The body 128 is considered “substantially cylindrical” because, although part of the body 128 has teeth 140 formed therein, the overall outer diameter of the body 128 is constant and does not taper from the second end 136 to the first end 132.

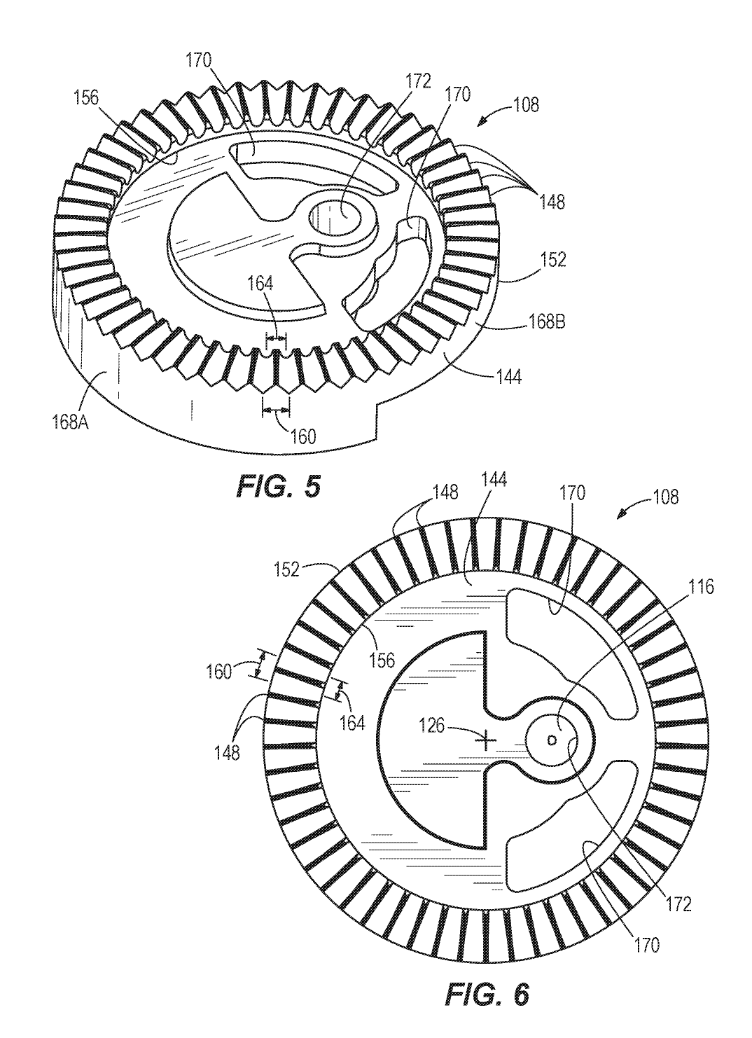

With respect to FIGS. 5 and 6, the driven gear 108 has a body 144 and a plurality of teeth 148 formed in a face of the body 144. In the illustrated embodiment, the teeth 148 are radially straight, as opposed to spiral-shaped or curved relative to the face of the body 144. That is, the illustrated driven gear 104 is a non-spiral bevel gear. Each of the teeth 148 has a variable width that is wider at an outer edge 152 of the driven gear 108 and narrows as the tooth extends radially inward. In other words, each tooth 148 has a first width 160 near the outer edge 152 of the driven gear 108 and second width 164 at a radially inward edge 156 of the driven gear 108. The first width 160 is larger than the second width 164. The teeth 140 of the driving gear 104 are configure to mate with the teeth 148 of the driven gear 108 so the driving gear 104 can rotate the driven gear 108.

The illustrated driven gear 108 is also configured as a counterweight. In particular, the body 144 of the driven gear 108 includes two sections of halves 168A, 168B. The first section or half 168A is a relatively thick section, while the second section or half 168B is a relatively thin section. In other words, the first section 168A has a greater mass than the second section 168B. In the illustrated embodiment, the body 144 also has one or more apertures 170 formed through the second section 168B. The apertures 170 further reduce the overall mass of the second section 168B relative to the first section 168A. Furthermore, the pin 116 is supported (e.g., fixed) within a corresponding opening 172 in the second section 168B between the two illustrated apertures 170.

In some embodiments, such as the illustrated embodiment, the driving gear 104, the driven gear 108, or both are molded components. For example, the gears 104, 108 may be molded of powdered metal. In other embodiments, the gears 104, 108 may be made of other suitable materials and/or may be made by other processes. Molding the gears 104, 108 from powered metal facilitates creating the intricate geometries of the gears 104, 108, such as the different thickness sections 168A, 168B and the apertures 170 of the driven gear 108.

Referring back to FIG. 3, the yoke 124 includes a shaft 176 that surrounds the pin 116 and is connected to a spindle 180. In the illustrated embodiment, the yoke 124 is integrally formed as a single piece with the spindle 180 such that the yoke 124 is part of the spindle 180. In other embodiments, the yoke 124 may be a separate piece that is secured to the spindle 180. The spindle 180 includes a spindle shaft 184 and a blade clamp (not shown) that is opposite the yoke 124. As shown in FIG. 2, a tool element 192, such as a saw blade, is coupled to the spindle shaft 184 via the blade clamp. The blade clamp can also be configured to accept a variety of reciprocating saw blades, jig saw blades, and/or hack saw blades.

The spindle 180 and the saw blade 192 are positioned along a longitudinal spindle axis 196 defined along a length of the spindle 180. During operation of the saw 10, the spindle 180 translates back and forth (e.g., reciprocates) along the longitudinal axis 196.

In operation, the driving gear 104, or pinion, is rotated by the output shaft of the motor 68. As the output shaft rotates, the pinion 104 rotates and engages the teeth 148 of the driven gear 108 to rotate the gear 108. Since the pin 116 is offset from an axis of rotation of the gear 108, the pin 116 moves around the axis of rotation as the driven gear 108 rotates. The yoke 124 translates back and forth due to the pin 116 pushing against the yoke 124 as the pin 116 moves about the axis of rotation. The yoke 124 in turn translates the spindle 180 in the desired reciprocating motion. As the driven gear 108 rotates, the relatively thick, first section 168A of the driven gear 108 moves in generally the opposite direction of the spindle 180 to counterbalance forces generated by the spindle 180 during reciprocation.

As shown in FIGS. 1 and 2, the saw 10 also includes a shoe assembly 200. In the embodiment shown, the shoe assembly 200 is a fixed shoe assembly. The shoe assembly 200 includes a front surface or plate 204 which engages or rests on a workpiece. The front plate 204 also defines an opening 208 for the saw blade 192 to pass through. The front plate 204 is coupled to two connecting members 212, which connect the shoe assembly 200 to the housing 40. In other embodiments, the shoe assembly 200 may be an adjustable shoe assembly in which the plate 204 is adjustably coupled to the connecting members 212 such that the shoe 204 is movable or pivotable relative to the connecting members 212.

Although the invention has been described in detail with reference to certain preferred embodiments, variations and modifications exist within the scope and spirit of one or more independent aspects of the invention as described. For example, in another embodiment, the driven gear 108 may be used in a power tool other than the reciprocating saw. Other tools that may include the driven gear 108 include an angle drill, a band saw, or any other type of power tool. Accordingly, the driven gear 108 is usable in place of a spiral bevel gear in an angle drill, a band saw, or any other type of power tool.

Various features and advantages of the invention are set forth in the following claims.

What is claimed is:

1. A power tool comprising:
a housing having a handle configured to be grasped by a user;
a motor supported by the housing;
a driving gear rotated by the motor, the driving gear have a substantially cylindrical body;
a driven gear engaging the driving gear to be rotated by the driving gear about a rotation axis;
a pin extending from the driven gear and offset from the rotation axis;
a spindle having a yoke coupled to the pin to translate rotation of the driven gear into reciprocating motion of the spindle; and
a tool element coupled to the spindle for reciprocating motion with the spindle.

2. The power tool of claim 1, wherein the driven gear includes a plurality of teeth, each tooth having a variable width.

3. The power tool of claim 2, wherein the teeth of the driven gear are radially straight.

4. The power tool of claim 2, wherein the driving gear has a plurality of teeth engaged with the plurality of teeth of the driven gear.

5. The power tool of claim 4, wherein each tooth of the driven gear has a first width at an outer edge of the driven gear and a second width radially inward of the outer edge, the first width being larger than the second width.

6. The power tool of claim 4, wherein the driven gear includes a first end and a second end, a dimension of the first end being substantially the same as a dimension of the second end, the plurality of teeth of the driven gear being positioned at the first end.

7. The power tool of claim 1, wherein the driving gear, the driven gear, or both the driving gear and the driven gear is molded of powdered metal.

8. The power tool of claim 1, wherein the driven gear includes a first half that is relatively thick and a second half that is relatively thin, and wherein the first half moves in a generally opposite direction of the spindle during operation to counterbalance the reciprocating motion of the spindle.

9. The power tool of claim 8, wherein the driven gear defines an aperture in the second half.

10. A power tool comprising:
a housing having a handle configured to be grasped by a user;
a motor supported by the housing;
a driving gear rotated by the motor, the driving gear having a first end and a second end, a dimension of the first end being substantially the same as a dimension of the second end;
a driven gear engaging the driving gear to be rotated by the driving gear about a rotation axis;
a pin extending from the driven gear and offset from the rotation axis;
a spindle having a yoke coupled to the pin to translate rotation of the driven gear into reciprocating motion of the spindle; and
a tool element coupled to the spindle for reciprocating motion with the spindle.

11. The power tool of claim 10, wherein the first end includes a plurality of teeth configured to mate with a plurality of teeth of the driven gear.

12. The power tool of claim 11, wherein the dimension of each of the first end and the second end is a diameter of the driving gear.

13. The power tool of claim 11, wherein each tooth of the plurality of teeth of the driven gear has a variable width.

14. The power tool of claim 11, wherein each tooth of the driven gear has a first width at an outer edge of the driven gear and a second width radially inward of the outer edge, the first width being larger than the second width.

15. The power tool of claim 10, wherein the driving gear, the driven gear, or both the driving gear and the driven gear is molded of powdered metal.

16. A drive system for a power tool, the drive system comprising:
a driving gear configured to be rotated by a motor, the driving gear have a substantially cylindrical body; and
a driven gear engaging the driving gear to be rotated by the driving gear about a rotation axis, the driven gear configured to actuate a tool element;
wherein the driving gear, the driven gear, or both the driving gear and the driven gear is molded of powered metal.

17. The drive system of claim 16, further comprising:
a pin extending from the driven gear and offset from the rotation axis; and
a spindle having a yoke coupled to the pin to translate rotation of the driven gear into reciprocating motion of the spindle, the spindle configured to reciprocate the tool element.

18. The power tool of claim 16, wherein the driven gear includes a plurality of teeth and the driving gear has as plurality of teeth engaged with the plurality of teeth of the driven gear, each tooth of the driven gear having a variable width.

19. The power tool of claim 18, wherein each tooth of the driven gear has a first width at an outer edge of the driven gear and a second width radially inward of the outer edge, the first width being larger than the second width.

20. The power tool of claim 18, wherein the driven gear includes a first end and a second end, a dimension of the first end being substantially the same as a dimension of the second end, the plurality of teeth of the driven gear being positioned at the first end.
